(19) United States
(12) Patent Application Publication
(10) Pub. No.: US 2009/0208177 A1
(43) Pub. Date: Aug. 20, 2009

(54) DROP TERMINAL WITH OPTICAL SPLITTER

(76) Inventor: Trevor D. Smith, Eden Prairie, MN (US)

Correspondence Address: MERCHANT & GOULD PC, P.O. BOX 2903, MINNEAPOLIS, MN, 55402-0903, US

(21) Appl. No.: 12/332,448

(22) Filed: Dec. 11, 2008

Related U.S. Application Data
(60) Provisional application No. 61/013,295, filed on Dec. 12, 2007.

(51) Int. Cl. G02B 6/00

(52) U.S. Cl. 385/135

(57) ABSTRACT

A fiber optic network includes a main cable with a breakout location. A tether optically connected to the main cable at the breakout location where the tether includes a single fiber connector. The single fiber connector optically coupled to an input on an input end of an optical splitter which is disposed in an interior cavity of a fiber drop terminal. Each of a plurality of outputs disposed on an output end of the optical splitter is optically coupled to an input of a distinct splitter disposed in an inner cavity of a distinct drop terminal.

### CROSS-REFERENCE TO RELATED APPLICATION

This application claims priority to U.S. Provisional Patent Application Ser. No. 61/013,295 filed on Dec. 12, 2007 and entitled “Drop Terminal with Optical Splitter,” the disclosure of which is hereby incorporated by reference in its entirety.

### TECHNICAL FIELD

The present disclosure relates to fiber optic networks, and more particularly, to fiber drop terminals in fiber optic networks.

### SUMMARY

An aspect of the present disclosure relates to a fiber drop terminal assembly having a housing defining an interior cavity with an optical splitter disposed in the interior cavity.

Another aspect of the present disclosure relates to a fiber optic network having a main cable with a breakout location. A tether optically connected to the main cable at the breakout location where the tether includes a single fiber connector. The single fiber connector optically coupled to an input on an input end of an optical splitter which is disposed in an interior cavity of a fiber drop terminal. Each of a plurality of outputs disposed on an output end of the optical splitter is optically coupled to an input of a distinct splitter disposed in an inner cavity of a distinct drop terminal.

Another aspect of the present disclosure relates to a fiber optic network including a main cable having a plurality of optical fibers and a plurality of mid-span breakouts. A tether includes a first end and a second end, where the first end is optically connected to the main cable at one of the mid-span breakouts and the second end includes a single fiber connector. A first fiber drop terminal assembly is optically connected to the single fiber connector of the tether. The first fiber drop terminal assembly includes a housing defining an interior cavity, a first optical splitter and a plurality of ruggedized adapters. The first optical splitter is disposed in the interior cavity of the housing. The first optical splitter includes an input disposed on an input end and a plurality of outputs disposed on an output end. The input of the first optical splitter is optically connected to the tether. The plurality of ruggedized adapters extends through openings in the housing of the fiber drop terminal assembly. Each of the adapters has a first end and a second end. The first end is disposed within the interior cavity and is adapted to receive a connectorized end of a pigtail that is optically connected to one of the outputs of the first optical splitter. The second end is accessible from an exterior of the fiber drop terminal assembly and is adapted to receive a single fiber connector. A plurality of fiber drop terminal assemblies is optically connected to the second ends of the plurality of ruggedized adapters of the first fiber drop terminal assembly. The plurality of fiber drop terminal assemblies defines interior cavities in which are disposed optical splitters having inputs in optical communication with the second ends of the plurality of ruggedized adapters of the first fiber drop terminal assembly.

Another aspect of the present disclosure relates to a method for expanding a fiber optic network. The method includes optically connecting a first fiber drop terminal assembly to a cable such that an input of a first optical splitter disposed in an interior cavity of the first fiber drop terminal assembly includes a plurality of ruggedized adapters having a first end that is disposed within the interior cavity and optically connected to one of a plurality of outputs of the first optical splitter and a second end that is accessible from an exterior of the first fiber drop terminal assembly. The method further includes optically connecting one of the second ends of the plurality of ruggedized adapters to an input of a second optical splitter disposed in an interior cavity of a second fiber drop terminal assembly. The second fiber drop terminal assembly includes a plurality of adapters having a first end that is disposed in the interior cavity of the second fiber drop terminal assembly and is optically connected to one of a plurality of outputs of the second optical splitter and a second end that is accessible from an exterior of the second fiber drop terminal assembly.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DESCRIPTION OF THE DRAWINGS

FIG. 1 is a schematic representation of a fiber optic network having exemplary features of aspects in accordance with the principles of the present disclosure.

FIG. 2 is a perspective view of a main cable suitable for use in the fiber optic network of FIG. 1.

FIG. 3 is a perspective view of a single fiber connector suitable for use in the fiber optic network of FIG. 1.

FIG. 4 is a perspective view of a fiber optic adapter suitable for use in the fiber optic network of FIG. 1.

FIG. 5 is a cross-sectional view of the fiber optic adapter of FIG. 4.

FIG. 6 is a perspective view of a fiber drop terminal suitable for use in the fiber optic network of FIG. 1.

FIG. 7 is a schematic representation of an expanded fiber optic network having exemplary features of aspect in accordance with the principles of the present disclosure.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

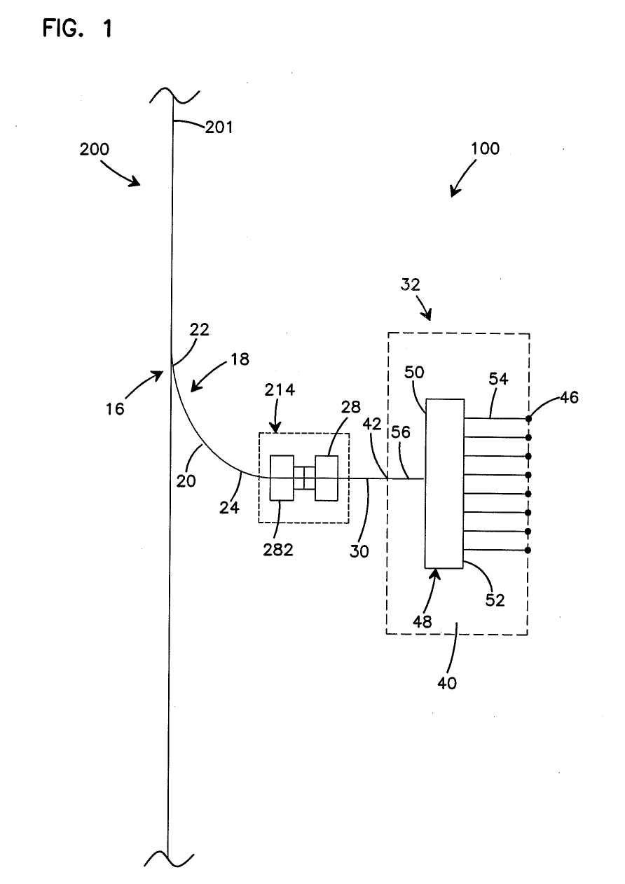

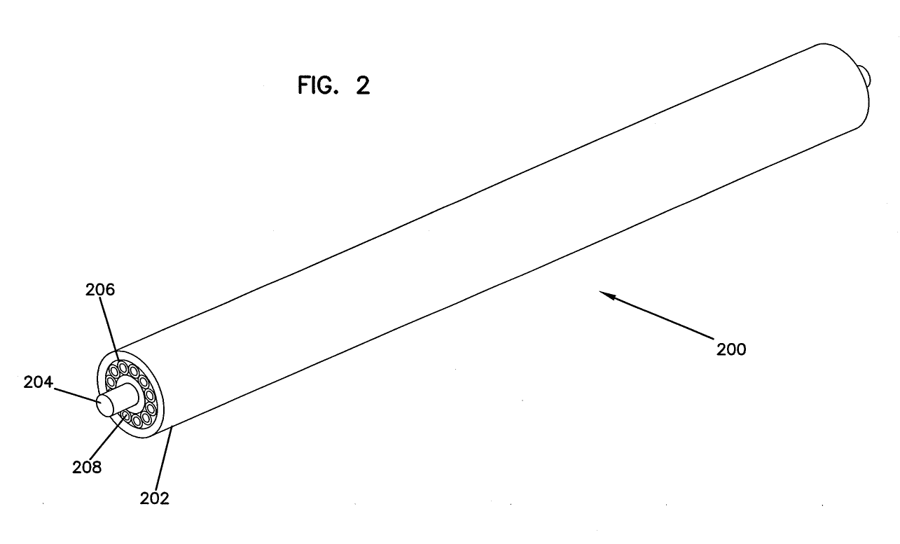

Referring now to FIG. 1, a schematic representation of an exemplary fiber optic network, generally designated 100, is shown. The fiber optic network 100 includes a main cable 200 having a plurality of optical fibers 201. An exemplary main cable 200 is shown in FIG. 2. The main cable 200 includes an outer jacket 202 that provides strength and abrasion resistance to optical fibers 201 running inside the main cable 200. The outer jacket 202 may be manufactured from UV resistant plastic and may include reinforcing fibers. In the subject embodiment, the main cable 200 further includes a strength member 204 passing through the center of the main cable 200. The strength member 204 can be used to tension the main cable 200 without damaging or stretching the optical fibers 201 running inside the main cable 200.

In the subject embodiment, the main cable 200 also includes fiber ribbons 206. A fiber ribbon 206 can include 4, 6, 8, 12, or more optical fibers 201 enclosed within a protective ribbon sheath 208.

Referring again to FIG. 1, the main cable 200 includes a plurality of mid-span breakout locations 16. The mid-span breakout locations 16 are typically provided at an intermediate point along the length of the main cable 200. The mid-span breakout locations 16 can correspond with geographic locations of utility poles or ground mounted pedestals. In the subject embodiment, a tether, generally designated 18, branches out from the main cable 200 at the breakout location 16. In the subject embodiment, the tether 18 is a single optical fiber 20. A fiber breakout has been described in U.S. patent application Ser. No. 11/406,826, which was filed on Apr. 19, 2006, entitled “Fiber breakout with integral connector”, and is hereby incorporated by reference in its entirety.

The tether 18 includes a first end 22 and a second end 24. The first end 22 of the tether 18 is spliced to the optical fiber 201 of the main cable 200. In the subject embodiment, the second end 24 of the tether 18 includes a ruggedized single fiber connector, generally designated 282. It will be understood, however, that the scope of the present disclosure is not limited to the second end 24 of the tether 18 having a ruggedized single fiber connector 282.

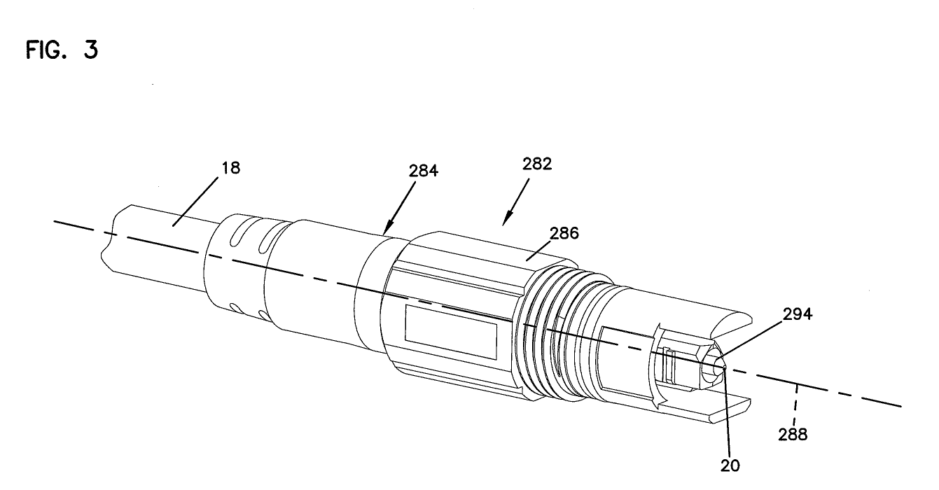

Referring now to FIG. 3, an exemplary embodiment of the ruggedized single fiber connector 282 is shown. The single fiber connector 282 includes a housing, generally designated 284, on which a retention nut 286 is rotatably mounted. The retention nut 286 can be manually rotated about a central axis 288 of the single fiber connector 282. The single optical fiber 20 of the tether 18 has an end portion mounted within a ferrule 294 supported at one end of the housing 284.

In the depicted embodiment of FIG. 1, the single fiber connector 282 is optically connected to a single fiber connectorized end 28 of a cable 30. In the subject embodiment, the single fiber connectorized end 28 is similar to the single fiber connector 282 shown in FIG. 3.

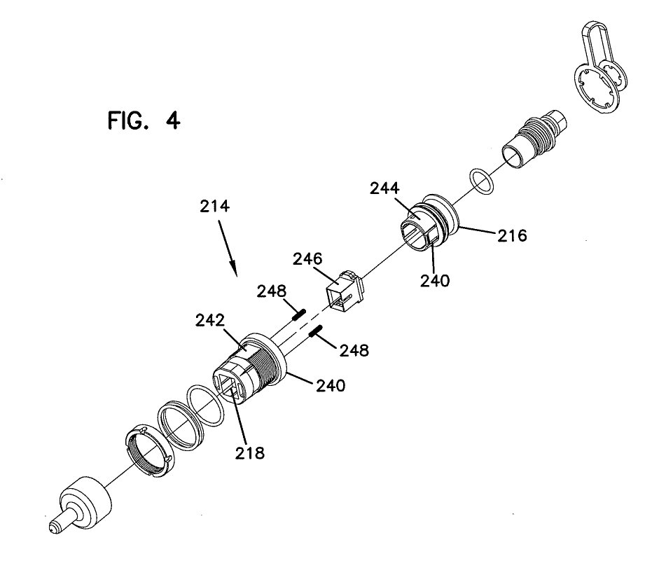

Referring now to FIGS. 1, 4 and 5, a fiber optic adapter 214 provides the optical connection between the single fiber connector 282 of the tether 18 and the single fiber connectorized end 28 of the cable 30. The fiber optic adapter 214 and the ruggedized connector 282 have been described in U.S. patent application Ser. No. 11/728,043, which was filed on Mar. 23, 2007, entitled “Drop terminal with anchor block for retaining a stub cable”, and hereby incorporated by reference in its entirety.

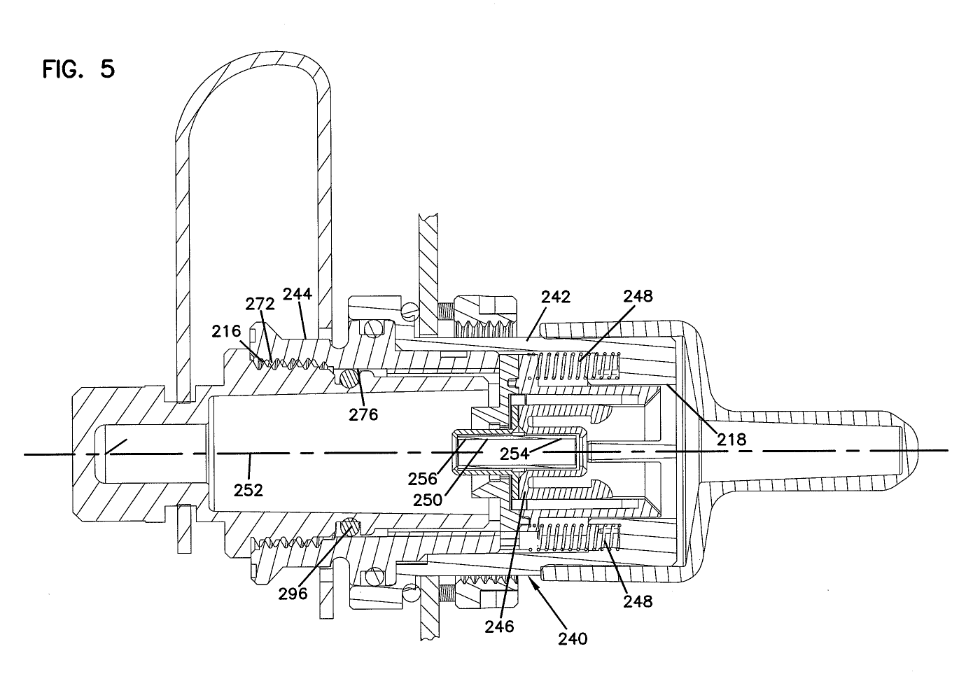

The fiber optic adapter 214 includes a first port 216 and a second port 218. The fiber optic adapter 214 further includes a main housing 240 having a first piece 242 that defines the second port 218 of the fiber optic adapter 214 and a second piece 244 that defines the first port 216 of the fiber optic adapter 214. The first and second pieces 242, 244 can be interconnected by a snap-fit connection to form the main housing 240. A split sleeve housing 246 mounts within the interior of the main housing 240. Springs 248 bias the split sleeve housing 246 toward the first port 216 and allow the split sleeve housing 246 to float within the interior of the main housing 240. As shown in FIG. 5, the split sleeve housing 246 houses a standard split sleeve 250 that is coaxially aligned with a center axis 252 of the fiber optic adapter 214. The split sleeve 250 includes a first end 254 that faces toward the second port 218 of the fiber optic adapter 214 and a second end 256 that faces toward the first port 216 of the fiber optic adapter 214.

To engage the single fiber connector 282 in the fiber optic adapter 214, the single fiber connector 282 is inserted within the first port 216 of the fiber optic adapter 214 such that the ferrule 294 is received within second end 256 of the split sleeve 250. In this way, the split sleeve 250 holds a ferrule of the single fiber connectorized end 28 in coaxial alignment with the ferrule 294 of the single fiber connector 282. By aligning the ferrules, the corresponding optical fibers 20, 30 are placed in coaxial alignment thereby allowing light signals to be transferred from fiber to fiber. The single fiber connector 282 is retained within the first port 216 by threading the retention nut 286 into internal threads 272. Additionally, the single fiber connector 282 includes a sealing member 296 (e.g., an O-ring) that engages a sealing surface 276 of the fiber optic adapter 214 to provide an environmental seal between the single fiber connector 282 and the fiber optic adapter 214.

In one embodiment, the ruggedized single fiber connector 282 of the tether 18 and the fiber optic adapter 214 are overmolded to the main cable 200 at the breakout location 16.

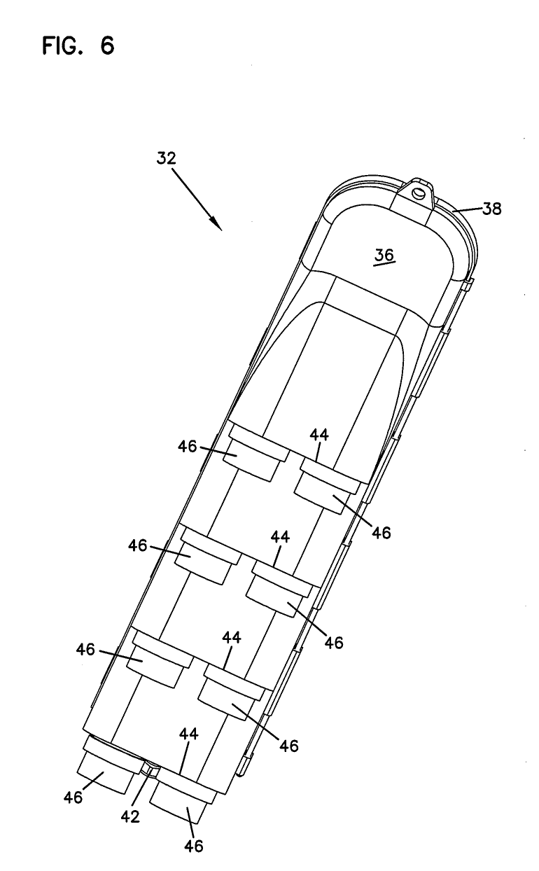

Referring now to FIGS. 1 and 6, the fiber optic network 100 includes a fiber drop terminal 32. The fiber drop terminal 32 includes a housing, generally designated 34, having a cover 36 and a base 38. Exemplary fiber drop terminals have been described in U.S. Pat. No. 7,292,763, which is hereby incorporated by reference in its entirety. In the subject embodiment, the cover 36 and the base 38 of the fiber drop terminal 32 cooperatively define an interior cavity 40 (shown in FIG. 1) and a cable entry 42 that provides a pathway into the interior cavity 40. At least one seal is positioned about the base 38 to provide a weather-tight seal between cover 36 and base 38.

The cover 36 of the fiber drop terminal 32 includes a plurality of mounting surfaces 44. In the subject embodiment, and by way of example only, the cover 36 defines four mounting surfaces 44. Each of the mounting surfaces 44 defines a plurality of openings. A plurality of adapters 46 are connectedly engaged with the openings of the mounting surfaces 44. In the subject embodiment, and by way of example only, two adapters 46 are disposed on each mounting surface 44. In the depicted embodiment, the adapters 46 are similar to the fiber optic adapters 214 earlier described. It will be understood, however, that the scope of the present disclosure is not limited to the adapters 46 being similar to the fiber optic adapter 214. Each adapter 46 includes a first end that is disposed within the interior cavity 40 of the fiber drop terminal 32 and a second end that is accessible from the exterior of the fiber drop terminal 32. Each of the first and second ends of the adapter 46 is adapted to receive a connectorized end of an optical fiber of a cable.

The fiber drop terminal 32 includes an optical splitter 48 that is disposed in the interior cavity 40. The optical splitter 48 includes an input end 50 and an output end 52. In the subject embodiment, the optical splitter 48 is a 1×8 splitter. Therefore, the optical splitter 48 includes a single input and eight outputs. It will be understood, however, that the scope of the present disclosure is not limited to the optical splitter 48 being a 1×8 splitter.

A plurality of pigtails 54 are connectedly engaged to each of the outputs on the output end 52 of the optical splitter 48. In the subject embodiment, each of the pigtails 54 is a single optical fiber having a connectorized end that is connectedly engaged to one of the adapters 46 such that each adapter 46 is connectedly engaged to one pigtail 54.

The cable 30 has the single fiber connectorized end 28 and a second end 56. The second end 56 of the cable 30 is optically connected to the input on the input end 50 of the optical splitter 48.

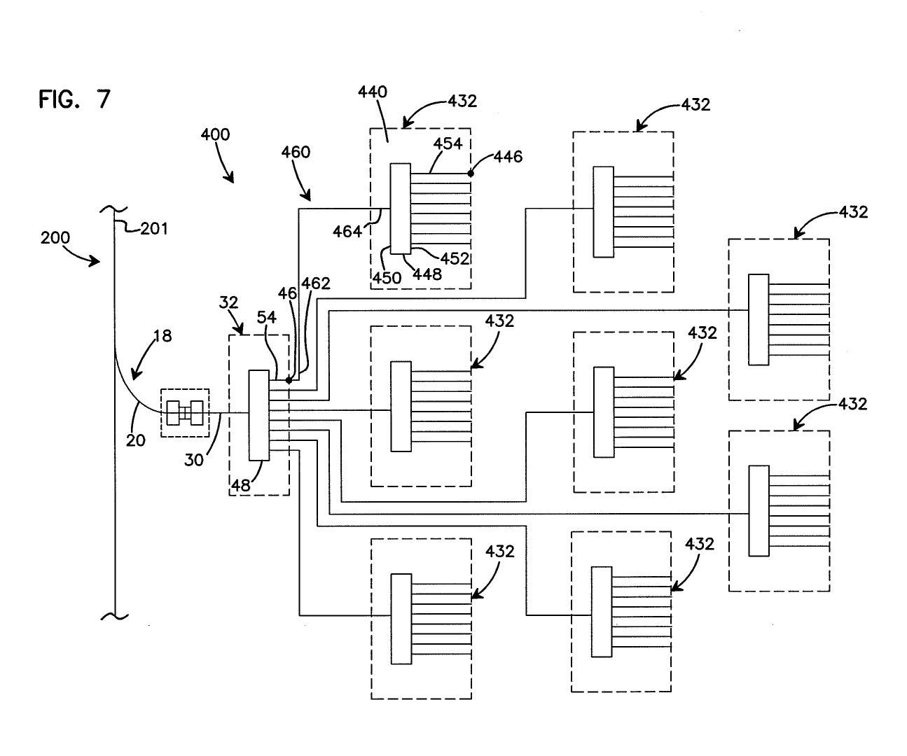

Referring now to FIG. 7, an expanded fiber optic network 400 is shown. The expanded fiber optic network 400 includes the main cable 200 having the optical fiber 201 and the tether 18 spliced to the optical fiber 201 of the main cable at the breakout location 16. The tether 18 is the single optical fiber 20. The tether 18 is optically connected to the cable 30, which is optically connected to the input of the optical splitter 48 disposed within the fiber drop terminal 32. The fiber drop terminal 32 includes adapters 46, each of which is optically connected to one of the outputs of the optical splitter 48 through pigtails 54.

The expanded fiber optic network 400 includes a plurality of distinct drop terminals 432. Each of the plurality of distinct drop terminals 432 define an inner cavity 440 in which is disposed a distinct splitter 448. The distinct splitter 448 includes an input disposed on an input end 450 and a plurality of outputs disposed on an output end 452. In the subject embodiment, and by way of example only, each of the distinct splitters 448 is a 1×8 splitter.

Each of the plurality of drop terminals 432 includes a plurality of mounting surfaces having a plurality of openings. A plurality of adapters 446 are mounted on the mounting surfaces such that a first end of the adapters 446 is disposed within the inner cavity 440 while a second end of the adapters 446 is accessible from the exterior of the drop terminal 432. Both the first and second ends of the adapters 446 are adapted to receive a connectorized end of a cable. The first end of each of the adapters 446 is optically coupled to one of the plurality of outputs on the splitter 448 through a pigtail 454, where the pigtail 454 is a cable having only a single optical fiber.

Each of the drop terminals 432 are optically connected to one of the adapters 46 of the fiber drop terminal 32 through a fiber cable 460 having only a single optical fiber. The fiber cable 460 includes a first end portion 462 and a second end portion 464. The first end portion 462 of the fiber cable 460 includes a single fiber connector end. The single fiber connector end of the fiber cable 460 is optically connected to one of the pigtails 54 of the fiber drop terminal through the adapter 46. The second end portion 464 of the fiber cable 460 is optically coupled to the input of the splitter 448 disposed within the drop terminal 432.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A fiber optic network comprising:
a main cable having a plurality of optical fibers and a plurality of mid-span breakouts;
a tether having a first end and a second end, wherein the first end is spliced to the main cable at one of the mid-span breakouts and the second end includes a single fiber connector; and
an optical splitter disposed in an interior cavity of a fiber drop terminal, the optical splitter having an input disposed on an input end of the optical splitter and a plurality of outputs disposed on an output end of the optical splitter, wherein the input is optically coupled to the single fiber connector of the tether and the outputs are optically coupled to inputs of distinct splitters disposed in inner cavities of distinct drop terminals.

2. A fiber optic network as claimed in claim 1, wherein the optical splitter is a 1×8 splitter.

3. A fiber optic network as claimed in claim 1, wherein the fiber drop terminal includes a weather-tight seal.

4. A fiber optic network as claimed in claim 3, wherein the fiber drop terminal includes a housing having a base and a cover.

5. A fiber optic network as claimed in claim 4, wherein at least one seal is disposed between the base and the cover.

6. A fiber optic network comprising:
a main cable having a plurality of optical fibers and a plurality of mid-span breakouts;
a tether having a first end and a second end, wherein the first end is spliced to the main cable at one of the mid-span breakouts and the second end includes a single fiber connector;
a first fiber drop terminal assembly optically connected to the single fiber connector of the tether, the first fiber drop terminal assembly including:
a housing defining an interior cavity;
a first optical splitter disposed in the interior cavity of the housing, the first optical splitter including an input disposed on an input end and a plurality of outputs disposed on an output end, wherein the input of the first optical splitter is optically connected to the tether;
a plurality of ruggedized adapters extending through openings in the housing of the fiber drop terminal assembly, each of the adapters having a first end disposed within the interior cavity and adapted to receive a connectorized end of a pigtail that is optically connected to one of the outputs of the first optical splitter, and a second end accessible from an exterior of the fiber drop terminal assembly and adapted to receive a single fiber connector;
a plurality of fiber drop terminal assemblies optically connected to the second ends of the plurality of ruggedized adapters of the first fiber drop terminal assembly, the plurality of fiber drop terminal assemblies defining interior cavities in which are disposed optical splitters having inputs in optical communication with the second ends of the plurality of ruggedized adapters of the first fiber drop terminal assembly.

7. A fiber optic network as claimed in claim 6, wherein the first optical splitter is a 1×8 splitter.

8. A fiber optic network as claimed in claim 6, wherein the first fiber drop terminal assembly includes a weather-tight seal.

9. A fiber optic network as claimed in claim 8, wherein the fiber drop terminal includes a housing having a base and a cover.

10. A fiber optic network as claimed in claim 9, wherein at least one seal is disposed between the base and the cover.

11. A method for expanding a fiber optic network, the method comprising:
optically connecting a first fiber drop terminal assembly to a cable such that an input of a first optical splitter disposed in an interior cavity of the first fiber drop terminal assembly is optically connected to the cable, wherein the first fiber drop terminal assembly includes a plurality of ruggedized adapters having a first end that is disposed within the interior cavity and optically connected to one of a plurality of outputs of the first optical splitter and a second end that is accessible from an exterior of the first fiber drop terminal assembly; and
optically connecting one of the second ends of the plurality of ruggedized adapters to an input of a second optical splitter disposed in an interior cavity of a second fiber drop terminal assembly, wherein the second fiber drop terminal assembly includes a plurality of adapters having a first end that is disposed within the interior cavity of the second fiber drop terminal assembly and optically connected to one of a plurality of outputs of the second optical splitter and a second end that is accessible from an exterior of the second fiber drop terminal assembly.

12. A method for expanding a fiber optic network as claimed in claim 11, wherein the cable is a tether that is optically connected to a main cable at a breakout location.

13. A method for expanding a fiber optic network as claimed in claim 11, wherein the first optical splitter is a 1×8 splitter.

14. A method for expanding a fiber optic network as claimed in claim 11, further comprising optically connecting another of the second ends of the plurality of ruggedized adapters of the first fiber drop terminal assembly to an input of a third optical splitter disposed in an interior cavity of a third fiber drop terminal assembly, wherein the third fiber drop terminal assembly includes a plurality of adapters having a first end that is disposed within the interior cavity of the third fiber drop terminal assembly and optically connected to one of a plurality of outputs of the third optical splitter and a second end that is accessible from an exterior of the third fiber drop terminal assembly.

15. A method for expanding a fiber optic network as claimed in claim 14, wherein each of the first, second and third first optical splitters is a 1×8 splitter.
